(19) United States
(12) Patent Application Publication
(10) Pub. No.: US 2015/0054935 A1
(43) Pub. Date: Feb. 26, 2015

(54) PORTABLE TERMINAL ADAPTOR FOR MICROSCOPE, AND MICROSCOPIC IMAGING METHOD USING THE PORTABLE TERMINAL ADAPTOR

(71) Applicant: MIRUC OPTICAL CO., LTD., Tokyo (JP)

(72) Inventor: Hiroaki MURAMATSU, Tokyo (JP)

(73) Assignee: MIRUC OPTICAL CO., LTD., Tokyo (JP)

(21) Appl. No.: 14/096,684

(22) Filed: Dec. 4, 2013

(30) Foreign Application Priority Data
Aug. 21, 2013 (JP) 2013-170873

(51) Int. Cl. G02B 21/36; G02B 21/24

(52) U.S. Cl. CPC G02B 21/362; G02B 21/24
USPC 348/79; 359/392

(57) ABSTRACT

A portable terminal adaptor for a microscope may be provided in a microscope to capture an image observed under the microscope by means of a camera of a portable terminal. The portable terminal adaptor may include a lens-barrel attachment fixed to a lens-barrel of the microscope, a portable-terminal placing base having a first imaging hole through which the image observed under the microscope passes, the portable terminal being placed on the portable-terminal placing base, and a portable-terminal holder holding the portable terminal placed on the portable-terminal placing base.

### TECHNICAL FIELD

The present invention relates to a portable terminal adaptor for a microscope, and a microscopic imaging method using the portable terminal adaptor. More specifically, the present invention relates to a portable terminal adaptor for a microscope, which is to be provided in a microscope in order to capture an image observed under the microscope with a camera of a portable terminal, and a microscopic imaging method using the portable terminal adaptor, by which an image observed under a microscope is captured with a camera of a portable terminal.

### BACKGROUND ART

A technique for taking a picture of an image observed under a microscope by means of a film camera, a digital camera, a camera function of a portable phone, or the like has been developed. Various adapters and attachments to be provided in the microscope in order to capture an image observed under a microscope with a film camera, a digital camera, or a camera function of a portable phone have been proposed.

Japanese Unexamined Utility Model Registration Application Publication No. 63-86614 discloses a microphotographic apparatus. This document describes that one end of a cylindrical adapter is attached to an eyepiece part of a portable microscope, and the other end thereof is attached to a reflex camera so as to be removable from the eyepiece part.

Japanese Registered Utility Model Publication No. 2599134 discloses a photomicrographic camera fixing apparatus using a simple camera. This apparatus can reliably support a camera, and ensures compatibility with multiple models of simple cameras by appropriately changing the position of its window hole for a lens in accordance with the model of a camera to be used. The above photomicrographic camera fixing apparatus is composed of a guide cylinder and a camera support unit. The camera support unit is provided with a notch in its main body. Removably attached to this notch is a light shielding plate, which enables the position of the lens window hole to be changed by varying its attachment angle. The lower part of the lens window hole is provided with a connection tube that fits into the guide cylinder. Furthermore, pinching boards are provided on each of three side edge portions of the main body of the camera support unit, and a pressing leaf spring is formed on the inner side of one of the opposing pinching boards.

Japanese Unexamined Patent Application Publication No. 2006-208857 discloses an attachment for a camera-equipped portable phone or a digital camera that can be used as a microscope. This document describes the followings. The attachment for a camera-equipped portable phone is composed of a base, a magnifying unit, and a stand. The base removably fixes the camera-equipped portable phone in such a way that the display is externally viewable and the camera lens is exposed while being oriented downward. The magnifying unit has an object lens and lighting. When the camera-equipped portable phone is fixed to the base, the optical axis of the object lens is aligned with that of the camera lens in the camera-equipped portable phone which is exposed from the base. The lighting shines predetermined illumination light on a subject. The stand supports the base so as to be movable in a direction parallel to the optical axis.

Herein, portable terminals refer to, among smart phones, tablets (or tablet terminals), portable phones, PHSs, PDAs and the like, portable terminal instruments equipped with an imaging function of a camera. Such a portable terminal can transmit microscopic observations through the Internet function as digital data. Moreover, the portable terminal can download an application through the Internet, and activate this application to subject a captured image to data processing such as the measuring of a distance or angle or the coloring of an image.

### SUMMARY OF INVENTION

### Technical Problem

The specifications of portable terminals differ for each maker's model. For example, the sizes of portable terminals, such as the short-side or long-side lengths or thicknesses, differ for each model. In particular, the fact that the position of a camera provided in a portable terminal is dependent on its model becomes highly problematic to portable terminal adaptors for a microscope which are to be provided in a microscope in order to capture an image observed under the microscope with a camera of a portable terminal. This is because it is impossible for an observer to directly check the position of the camera with the eyes when aligning the optical axis of the camera provided in the portable terminal with that of the lens barrel of the microscope before capturing an image observed under the microscope. In order to capture an image observed under a microscope with high quality by using a camera of a portable terminal, however, it is necessary to align the optical axis of the camera with that of the lens barrel of the microscope precisely in accordance with a subject. Thus, “versatile” adapters are required, which conform to various portable terminal specifications.

Since portable terminals are communication instruments which the users carry and use daily, it is unrealistic to use a portable terminal attached to a microscope permanently. A method of using a portable terminal is accordingly conceivable, in which a process of attaching the portable terminal to a microscope as needed and detaching the portable terminal therefrom after the use is repeated. On the other hand, it is preferable that microscopic observations be transmitted through the Internet function of a portable terminal as digital data, and in this case, a “detachable” adapter is also required, which can easily be attached to or detached from a portable terminal.

Portable terminals are not basically designed to capture an image observed under a microscope with its built-in camera. Therefore, an adapter for connecting a portable terminal to a microscope is prone to become either an expensive instrument equipped with a complex connection mechanism or an inconvenient instrument that involves a complex connection method. As a result, the use of such an adapter may be avoided by the user. Therefore, “easily operable” adapters are required, which enables an image observed under a microscope to be easily captured with an attached portable terminal.

An object of the present invention is to provide a portable terminal adaptor for a microscope which: addresses the above-mentioned problems; conforms to portable terminal specifications that differ for each model; can attach/detach a portable terminal to or from a microscope; and can capture an image observed under the microscope through a simple operation, and to provide a microscopic imaging method using the portable terminal adaptor.

### Solution to Problem

In order to achieve the above-described object, a portable terminal adaptor for a microscope according to the present invention is provided in a microscope to capture an image observed under the microscope by means of a camera of a portable terminal, and is characterized in that: it includes a lens-barrel attachment fixed to a lens-barrel of a microscope; a portable-terminal placing base having a first imaging hole through which the image observed under the microscope passes, the portable terminal being placed on the portable-terminal placing base; and a portable-terminal holder holding the portable terminal placed on the portable-terminal placing base.

According to the above-described configuration, a portable terminal adaptor for a microscope according to the present invention is configured with a minimum number of components, including a lens-barrel attachment, a portable-terminal placing base, and a portable-terminal holder, which connect a microscope and a portable terminal, and is capable of capturing an image observed under a microscope through a simple operation. In addition, a portable terminal placed on the portable-terminal placing base is held by the portable-terminal holder. Consequently, the portable terminal adaptor for a microscope can conform to a wide variety of portable terminal specifications that differ for each model. Utilizing the portable-terminal holder makes it possible to eliminate the need to place a portable terminal in a microscope permanently and to easily attach/detach the portable terminal to or from the microscope, as will be described later.

In the portable terminal adaptor for a microscope, it is preferable for the portable-terminal holder to comprise a portable-terminal support unit that detachably supports a bottom of the portable terminal, and a position setting lock screw. In addition, it is preferable that a placement position of the portable terminal that has been supported and positioned by the portable-terminal holder is set in the portable-terminal holder by tightening the position setting lock screw to a side of the portable-terminal holder. In this manner, by supporting the portable terminal with the portable-terminal holder and fixing this portable-terminal holder to the portable-terminal placing base, the portable terminal is set at an appropriate position. When the portable terminal is detached from the portable-terminal holder and then is reattached thereto, it can be placed on the portable-terminal placing base without involving any additional positioning. Accordingly, it is only necessary to position a predetermined portable terminal and to set it at an appropriate position for the first time. It is thus possible to eliminate the need to place a portable terminal in a microscope permanently and to attach/attach the portable terminal to or from the microscope easily.

In the portable terminal adaptor for a microscope, it is preferable for the portable-terminal holder to comprise a portable-terminal storage unit that removably accommodates the portable terminal, and a position setting fixation screw. In addition, it is preferable that a placement position of the portable terminal that has been accommodated and positioned in the portable-terminal holder is set in the portable-terminal holder by tightening the position setting fixation screw to a side of the portable-terminal holder. In this manner, by placing the portable terminal in the portable-terminal holder and fixing this portable-terminal holder to the portable-terminal placing base, the portable terminal is set at an appropriate position. When the portable terminal is detached from the portable-terminal holder and then is reattached thereto, it can be placed on the portable-terminal placing base without involving any additional positioning. Accordingly, it is only necessary to position a predetermined portable terminal and to set it at an appropriate position for the first time. It is thus possible to eliminate the need to place a portable terminal to a microscope permanently and to attach/attach the portable terminal to or from the microscope easily.

In the portable terminal adaptor for a microscope, it is preferable for the portable-terminal placing base to be provided with an indicating line that is used as a reference mark when the portable terminal is positioned. In addition, it is preferable for the indicating line to at least show a substantially central position of the first imaging hole provided in the portable-terminal placing base. With the help of the indicating line provided in the portable-terminal placing base, the position of a camera in a portable terminal, which is dependent on its model, can be adjusted easily. Consequently, the indicating line enables the portable terminal adaptor for a microscope to conform to portable terminal specifications that differ for each model.

In the portable terminal adaptor for a microscope, it is preferable that a non-slip sheet having a second imaging hole be deployed between the portable terminal and the portable-terminal placing base. In addition, it is preferable for the non-slip sheet to have transparency that is high enough to identify the indicating line provided in the portable-terminal placing base. As a result, even when a portable terminal is placed on the angled portable-terminal placing base, it can be fixed to the portable-terminal placing base without being slipped or moved, by means of the adhesive force of the non-slip sheet.

In the portable terminal adaptor for a microscope, it is preferable for the lens-barrel attachment to be composed of a flat part and a cylinder part that is provided with a U-shaped slit in its axial direction. In addition, it is preferable for the cylinder part to be attached to the lens-barrel by putting an eyepiece cap screw provided in the lens-barrel into the U-shaped slit. As a result, the attached orientation of the flat part of the lens-barrel attachment can be adjusted relative to the position of the eyepiece cap screw.

In the portable terminal adaptor for a microscope, it is preferable that a manual stage is provided in the microscope for adjusting back-and-forth and right-and-left positions of a sample so as to be substantially aligned with an optical axis of the portable terminal. As a result, the position of an image observed under the microscope can be adjusted relative to a camera of a portable terminal.

In the portable terminal adaptor for a microscope, it is preferable for the manual stage to be composed of a stage selected alone or a plurality of stages selected in combination from among an X-axis stage that slides in one direction, an XY-axis stage that slides in two intersecting directions, a rotation stage that slides in a rotational direction, and a tilting stage whose stage slides in a tilting direction. In addition, it is preferable for the manual stage to be installed in an exchangeable manner and the adjustment of the positions being performed. As a result, the position of an image observed under the microscope can be adjusted in a short-side direction, a long-side direction, a rotational direction, a tilting direction, or a combination thereof, relative to the camera of the portable terminal.

In order to achieve the above-described object, a microscopic imaging method using a portable terminal adaptor according to the present invention includes the steps of: holding a portable terminal in a portable-terminal holder provided in the portable terminal adaptor; positioning the portable terminal by sliding the portable-terminal holder; fixing the portable-terminal holder to a portable-terminal placing base by a fastener; and capturing an image of a subject observed under a microscope with a camera of the portable terminal.

The above configuration makes it only necessary to perform a simple operation of placing the portable terminal on the portable-terminal placing base and holding it with the portable-terminal holder, as initial setting to be performed when a predetermined portable terminal is used. The portable terminal adaptor can conform to portable terminal specifications that differ for each model by sliding and positioning the portable-terminal holder. Furthermore, the portable terminal can be easily attached/detached to or from the microscope by fixing the portable-terminal holder to the portable-terminal placing base, as will be described later.

It is preferable for the microscopic imaging method using a portable terminal adaptor to further include the steps of: detaching the portable terminal that has captured the image, from the portable-terminal holder; reattaching the portable terminal to the portable-terminal holder fixed to the portable-terminal placing base; and capturing an image of a subject observed under the microscope with the camera of the portable terminal. By temporarily holding the portable terminal with the portable-terminal holder and fixing this portable-terminal holder to the portable-terminal placing base, the portable terminal is set at an appropriate position. Even when the portable terminal is detached from the portable-terminal holder and then is reattached thereto, it can be placed on the portable-terminal placing base without involving any additional positioning. Accordingly, it is only necessary to position a predetermined portable terminal and to set it at an appropriate position for the first time. It is thus possible to eliminate the need to place a portable terminal in a microscope permanently and to attach/attach the portable terminal to or from the microscope easily.

It is preferable for the microscopic imaging method using a portable terminal adaptor to further include the step of positioning the portable terminal relative to the portable-terminal placing base, on the basis of an indicating line provided in the portable-terminal placing base. In this step, with the help of the indicating line provided in the portable-terminal placing base, the position of a camera in a portable terminal, which is dependent on its model, can be adjusted easily. Consequently, the indicating line enables the portable terminal adaptor to conform to portable terminal specifications that differ for each model.

It is preferable for the microscopic imaging method using a portable terminal adaptor to further include the step of deploying a non-slip sheet between the portable terminal and the portable-terminal placing base. In this step, even when the portable terminal is placed on the angled portable-terminal placing base, it can be fixed to the portable-terminal placing base without being slipped, moved or angled, by means of the adhesive force of the non-slip sheet.

### Advantageous Effects of Invention

As described above, the present invention provides a portable terminal adaptor for a microscope which: conforms to portable terminal specifications that differ for each model; can attach/detach a portable terminal to or from a microscope; and makes it possible to capture an image observed under the microscope through a simple operation, and provides a microscopic imaging method using the portable terminal adaptor.

### BRIEF DESCRIPTION OF DRAWINGS

FIG. 1 is a perspective view schematically showing a configuration of a portable terminal adaptor for a microscope according to an embodiment of the present invention, the portable terminal adaptor being attached to the microscope.

FIG. 2 is an exploded perspective view showing the portable terminal adaptor for a microscope in FIG. 1 from the rear.

FIG. 3 is an exploded perspective view showing a lens-barrel attachment, a non-slip sheet, and a portable-terminal holder, which constitute the portable terminal adaptor for a microscope.

FIG. 4 is an exploded perspective view showing the non-slip sheet and the portable-terminal holder which are to be attached to a portable-terminal placing base.

FIG. 5A is an elevational view showing a portable-terminal holder according to a first embodiment of the present invention.

FIG. 5B is an elevational view showing a portable-terminal holder according to a second embodiment of the present invention.

FIG. 6 is a cross-sectional view of the portable-terminal holder according to the first embodiment, taken along a line A-A of FIG. 5A.

FIG. 7 is a cross-sectional view of the portable-terminal holder according to the first embodiment, taken along a line B-B of FIG. 5A.

FIG. 8 is a cross-sectional view of the portable-terminal holder, taken along a line C-C of FIG. 6.

FIG. 9 is a sectional view of the portable-terminal holder according to the second embodiment, taken along a line D-D of FIG. 5B.

FIG. 10 is a sectional view of the portable-terminal holder according to the second embodiment, taken along a line E-E of FIG. 5B.

FIG. 11 is a sectional view of the portable-terminal holder, taken along a line F-F of FIG. 9.

FIG. 12 shows top and side views of an X-axis stage as an example of a position adjusting manual stage.

FIG. 13 shows top and side views of an XY-axis stage as another example of the position adjusting manual stage.

FIG. 14 shows top, side and bottom views of a rotation stage as still another example of the position adjusting manual stage.

FIG. 15 shows perspective, side and top views of a tilting stage which is an example of the position adjusting manual stage.

FIG. 16 is a flowchart of a microscopic imaging method using the portable terminal adaptor according to an embodiment of the present invention.

### DESCRIPTION OF EMBODIMENTS

### (Configuration of Portable Terminal Adaptor for Microscope)

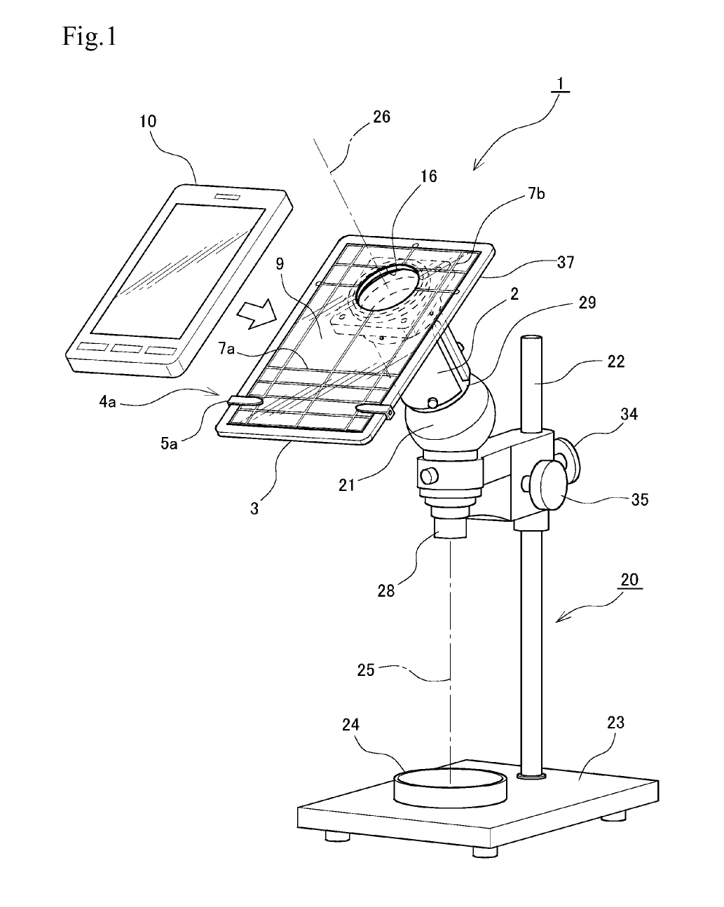

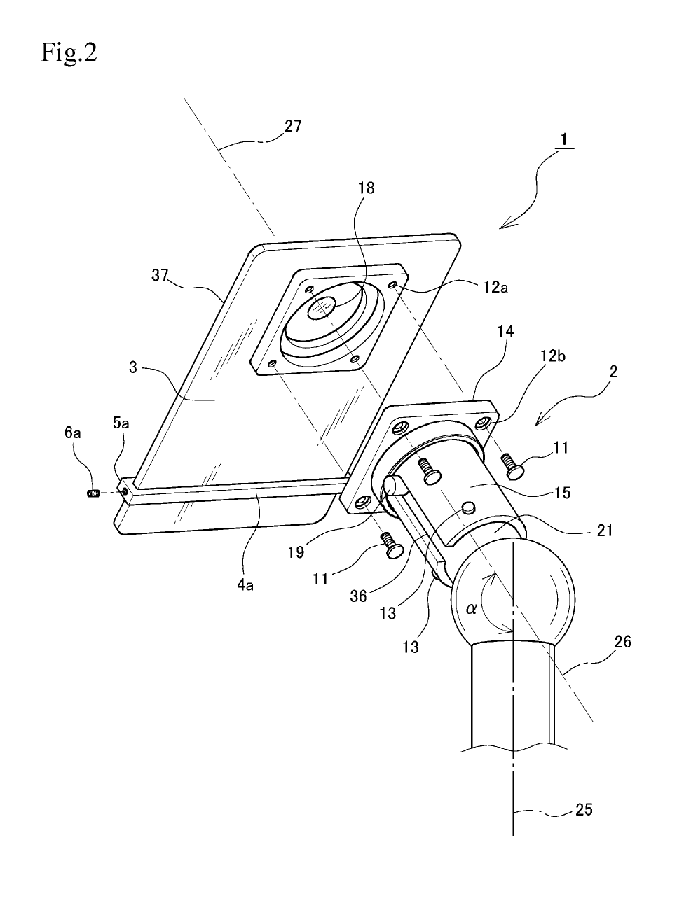

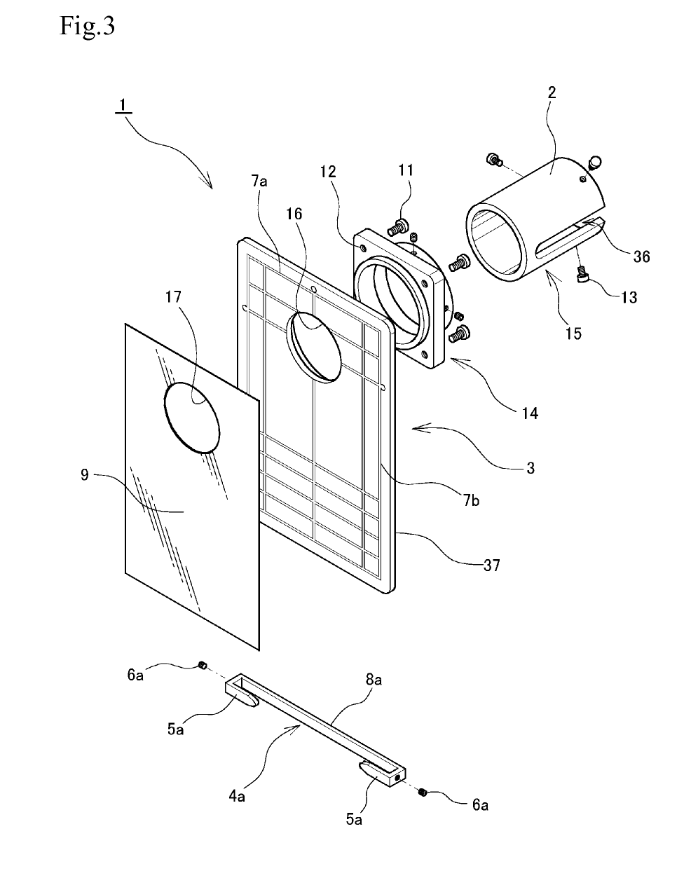

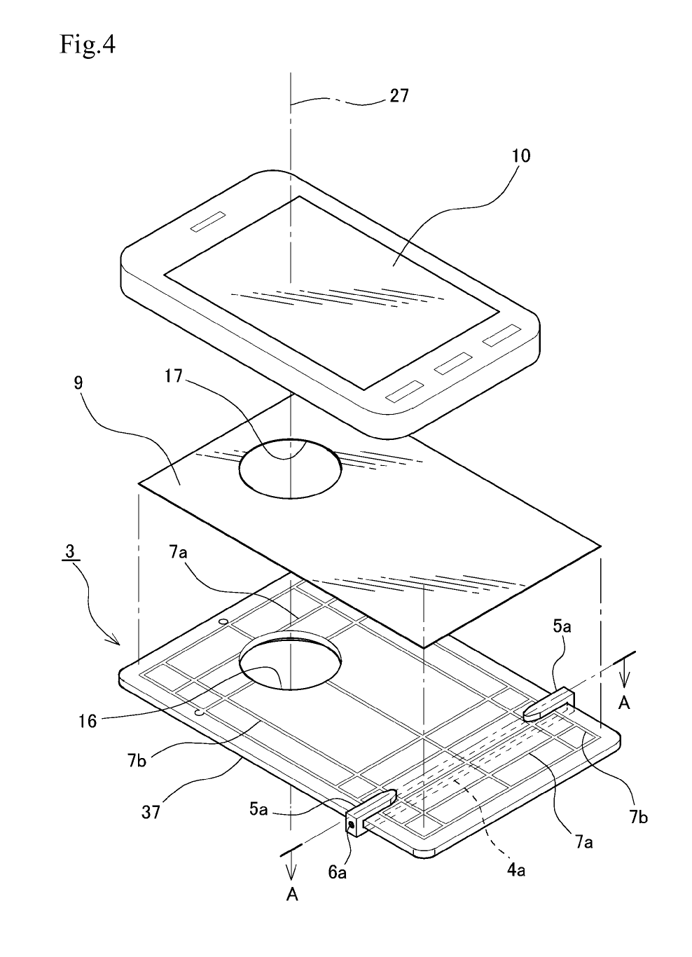

Hereinafter, a portable terminal adaptor 1 for a microscope according to an embodiment of the present invention will be described in detail with reference to the accompanying drawings. FIG. 1 is a perspective view schematically showing a configuration of a portable terminal adaptor 1 for a microscope according to an embodiment of the present invention, the portable terminal adaptor being attached to a microscope 20. FIG. 2 is an exploded perspective view showing the portable terminal adaptor for a microscope of FIG. 1 from the rear. FIG. 3 is an exploded perspective view showing a lens-barrel attachment 2, a portable-terminal placing base 3, a non-slip sheet 9, and a portable-terminal holder 4a, which constitute the portable terminal adaptor 1 for a microscope. FIG. 4 is an exploded perspective view showing the non-slip sheet 9 and the portable-terminal holder 4a which are to be attached to the portable-terminal placing base 3.

The microscope 20, which is targeted in these embodiments, is a known microscope generally used. In the microscope 20 in FIG. 1, a sample 24 placed on a stand 23, or a subject, is observed through an object lens 28. An observer adjusts the vertical position of the object lens 28 relative to the stand 22, and fixes the object lens 28 at that position by rotating a fixation screw handle 34. Then, the observer finely adjusts the vertical position of the object lens 28 by rotating a fine adjustment sliding handle 35 while looking through an eyepiece 29, thereby bringing the sample 24 into focus. An optical axis 25 of the object lens 28 is refracted by a prism in the microscope 20, becoming an optical axis 26 of the eyepiece 29 in a lens-barrel 21 provided above the object lens 28. The observer observes the sample 24 while looking through the eyepiece 29 in the lens-barrel 21 in accordance with the refracted optical axis 26 of the lens-barrel 21.

Typically, the lens-barrel 21 of the microscope 20 is so angled that the observer easily looks through the eyepiece 29. More specifically, the lens-barrel 21 is angled at approximately 45° relative to a horizontal surface. In other words, the optical axis 25 of the microscope 20 (the optical axis of the object lens) forms an angle of approximately 135° with the optical axis 26 of the lens-barrel 21 (the optical axis of the eyepiece). Hereinafter, this angle refers to a lens-barrel angle (α) (see FIG. 2). However, in another microscope 20, a lens-barrel angle (α) may be approximately 90°, that is, a lens-barrel 21 is set in a substantially lateral position. Furthermore, in another microscope 20, the lens-barrel angle (α) may be approximately 180°, that is, a lens-barrel 21 is set in a substantially vertical position. They may be selectively used depending on the observation purpose.

As shown in FIG. 1, the portable terminal adaptor 1 for a microscope is provided as an adapter installed in the microscope 20 in order to capture an image observed under the microscope 20 with a camera 18 provided in a portable terminal 10. The portable terminal adaptor 1 for a microscope is basically composed of the lens-barrel attachment 2, the portable-terminal placing base 3, and a portable-terminal holder 4. The lens-barrel attachment 2 is attached to the lens-barrel 21 of the microscope 20. The portable-terminal placing base 3 is attached to the lens-barrel attachment 2. The portable terminal 10 is placed on the portable-terminal placing base 3. As mentioned above, the lens-barrel angle (α) is typically 135°, and the portable terminal 10 is angled at approximately 45° relative to the lateral surface. However, when the lens-barrel angle (α) of the microscope 20 is approximately 90°, the portable terminal 10 is set in a substantially vertical position. When the lens-barrel angle (α) of the microscope 20 is approximately 180°, the portable terminal 10 is set in a substantially lateral position.

As shown in FIGS. 2 and 3, the lens-barrel attachment 2 is fixed to the lens-barrel 21 of the microscope 20. The lens-barrel attachment 2 is composed of a flat part 14 and a cylinder part 15. The cylinder part 15 has an inner diameter that is large enough to wrap the lens-barrel 21, and is joined to the lens-barrel 21 of the microscope 20. The cylinder part 15 is fixed to the flat part 14 by tightening four fixation screws (not shown) disposed around the cylinder part 15. The lens-barrel attachment 2 is fixed to the lens-barrel 21 by attachment fixation screws 13. The lens-barrel 21 is provided with an eyepiece cap screw 19, which is inserted into a slit 36 provided in the lens-barrel attachment 2. By fitting the eyepiece cap screw 19 into the slit 36, the flat part 14 is fixed precisely while being oriented in an appropriate direction. That is, since the position of the eyepiece cap screw 19 is fixed relative to the lens-barrel 21, the position of the lens-barrel attachment 2 is also fixed relative to it. Furthermore, base fixation screw holes 12b are provided in the flat part 14, and base fixation screw holes 12a are provided on the rear surface of the portable-terminal placing base 3 at the respective locations opposing the base fixation screw holes 12b. The portable-terminal placing base 3 is connected to the flat part 14 by base fixation screws 11, so that they are mutually fixed. In this manner, the lens-barrel 21 is connected to both the lens-barrel attachment 2 and the portable-terminal placing base 3 so that the optical axis 27 of the portable terminal 10 is substantially aligned with the optical axis 26 of the lens-barrel 21.

The size or shape of the lens-barrel 21 in the microscope 20 is dependent on its microscope maker. Therefore, preparing lens-barrel attachments 2 that are compatible with specifications of microscopes 20 produced by various makers makes it possible to provide the portable terminal adaptor 1 for a microscope which conforms to various microscopes 20.

As shown in FIG. 3, the portable-terminal placing base 3 has a first imaging hole 16 through which an image observed under the microscope passes. As shown in FIG. 4, the portable terminal 10 is placed on the portable-terminal placing base 3. In this case, the portable terminal 10 may be placed on the portable-terminal placing base 3 through a non-slip sheet 9 having a second imaging hole 17. As shown in FIG. 4, the portable-terminal placing base 3 and the non-slip sheet 9 are placed with respect to the portable terminal 10 such that optical axis 27 of the portable terminal 10 passes through substantially the respective centers of the first imaging hole 16 and the second imaging hole 17.

Various products have been widespread as the portable terminal 10, and they have various short-side and long-side sizes. Therefore, the portable-terminal placing base 3 has a longitudinal shape that complies with the size of the portable terminal 10, and its long-side and short-side sizes are determined such that many portable terminals 10 can be placed thereon. In these embodiments, the portable-terminal placing base 3 has a flat shape with a predetermined thickness, and is provided with outer edges 37 as shown in FIGS. 3 and 4. In these embodiments, the portable-terminal placing base 3 is made of a colored resin; however it may be made of a transparent or translucent material instead.

### (Configuration of Portable-Terminal Holder)

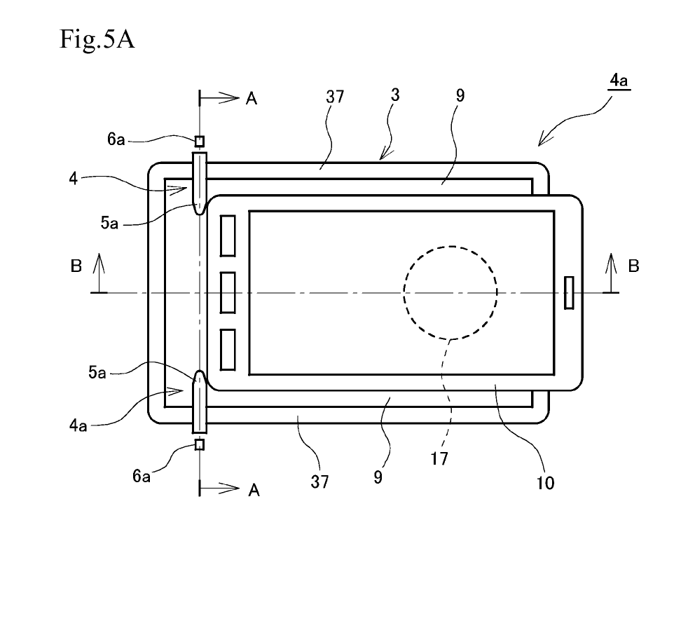

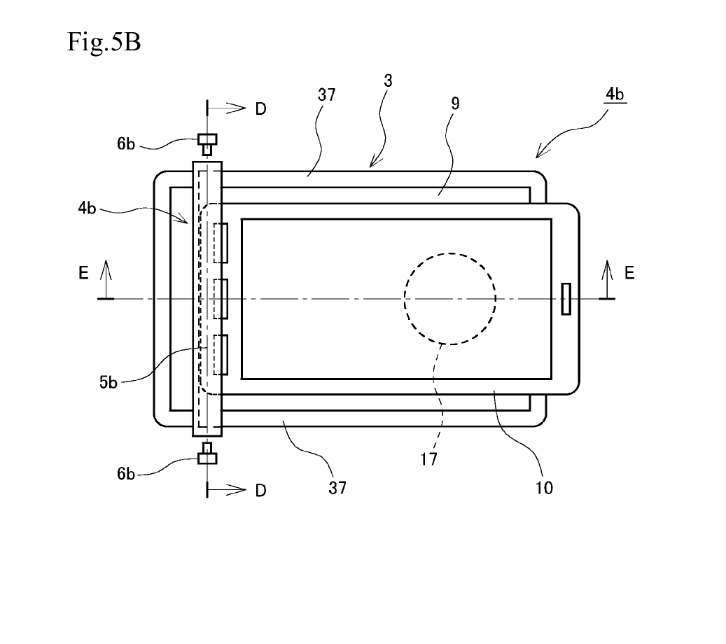

FIGS. 5A and 5B are elevational views showing the portable-terminal holder 4. Specifically, FIG. 5A illustrates a portable-terminal holder 4a according to a first embodiment of the present invention, and FIG. 5B illustrates a portable-terminal holder 4b according to the second embodiment of the present invention. Although the portable-terminal holder 4 illustrated in FIGS. 1 to 4 corresponds to the portable-terminal holder 4a in the first embodiment, it may correspond to the portable-terminal holder 4b in the second embodiment instead. The portable-terminal holder 4 is provided as a component which serves the purpose of holding the portable terminal 10 placed on the portable-terminal placing base 3. Accordingly, the portable-terminal holder 4 is not limited to those in the first embodiment or in the second embodiment, as long as it can hold the portable terminal 10 placed on the portable-terminal placing base 3. Here, the expression “holding the portable terminal 10 placed on the portable-terminal placing base 3” refers to fixing the positioned portable terminal 10 in place with its bottom supported or held. The expression “positioning the portable terminal 10” refers to adjusting the position of the portable terminal 10 relative to the portable-terminal placing base 3 in such a way that the optical axis 27 of the camera 18 provided on the rear surface of the portable terminal 10 is substantially aligned with the optical axis 26 of the lens-barrel 21.

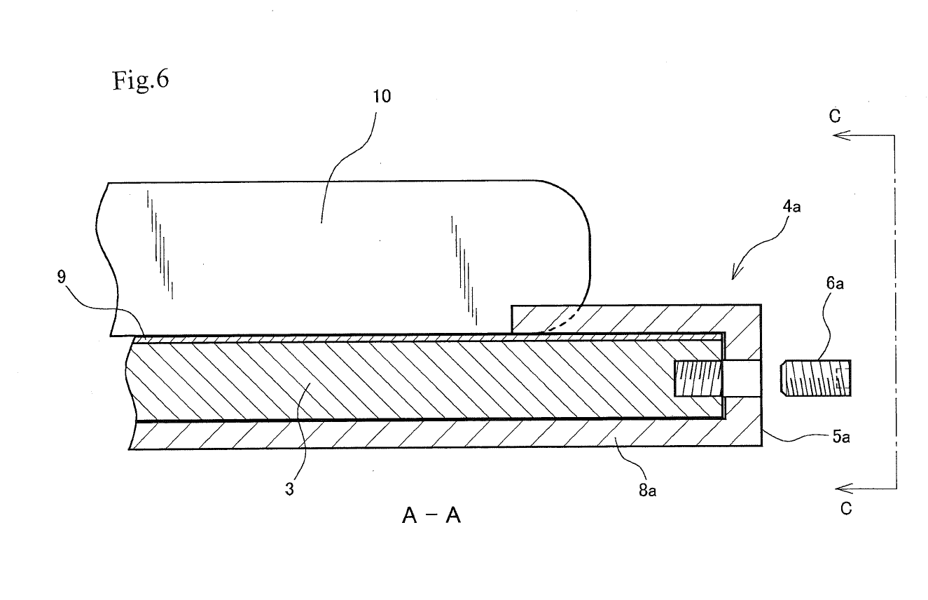

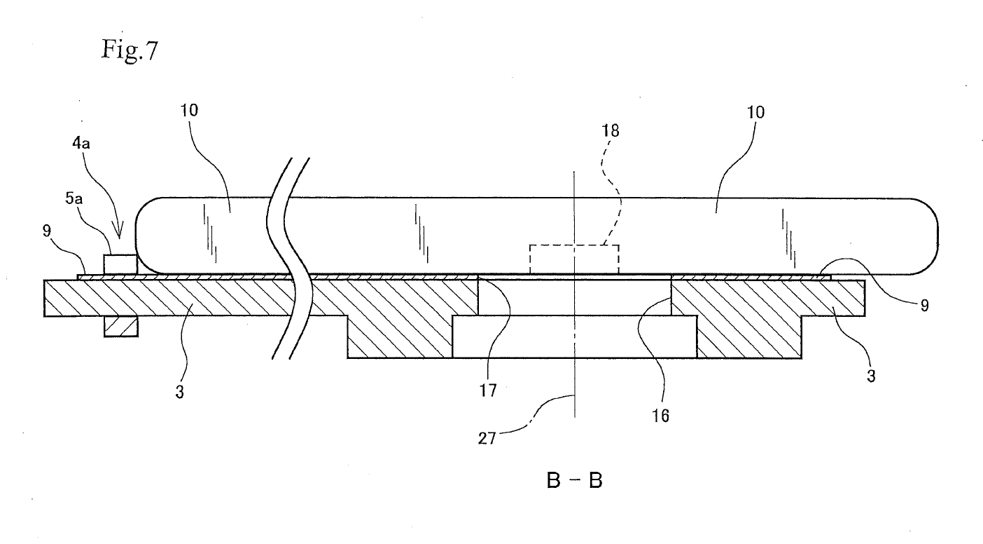

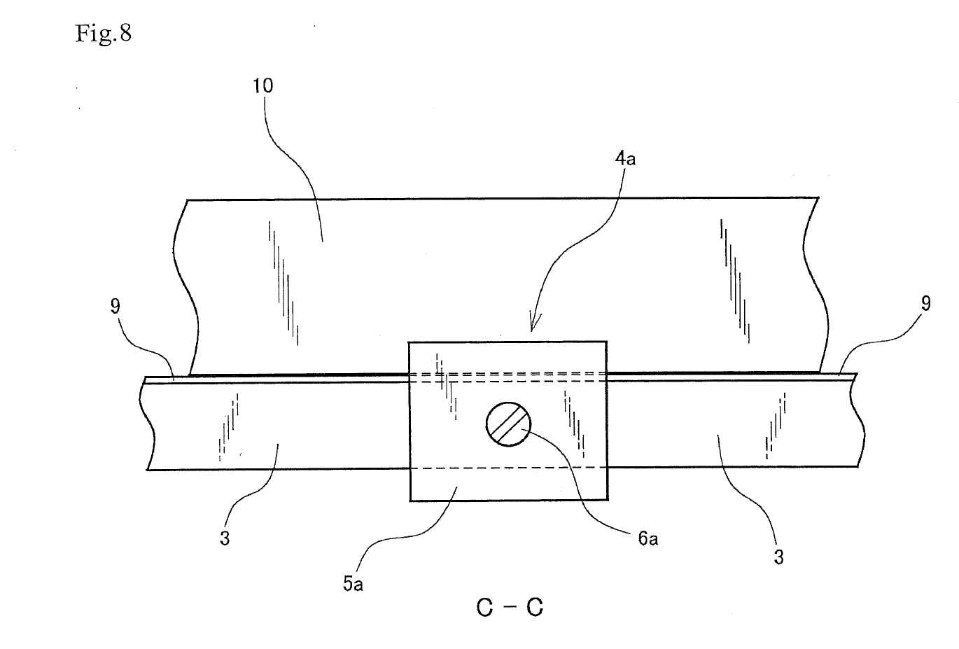

FIG. 6 illustrates a cross section of the portable-terminal holder 4a according to the first embodiment, taken along a line A-A in FIG. 5A. FIG. 7 illustrates a cross section thereof, taken along a line B-B in FIG. 5A, and FIG. 8 illustrates a cross section thereof, taken along a line C-C in FIG. 6. FIG. 3 illustrates the entire portable-terminal holder 4a in perspective. The portable-terminal holder 4a in the first embodiment includes: portable-terminal holding portions 5a shown in FIG. 7 which detachably supports the bottom of the portable terminal 10; a connecting unit 8a shown in FIG. 6 which connects respective ends of the portable-terminal holding portions 5a; and position setting lock screws 6a shown in FIG. 8. As shown in FIG. 5A, the portable terminal 10 sits on the portable-terminal holder 4a with its bottom being in contact with the respective ends of the portable-terminal holding portions 5a. More specifically, the portable-terminal holder 4a serves as a stopper for the portable terminal 10 by clamping the portable-terminal placing base 3 with the portable-terminal holding portions 5a arranged on both sides of the portable-terminal holder 4a, as shown in FIGS. 3 and 6. While the portable terminal 10 is positioned and supported by the portable-terminal holder 4a, the position setting lock screws 6a are tightened to corresponding outer edges 37 of the portable-terminal holder 4a. As a result, the placement position of the portable terminal 10 is set by the portable-terminal holder 4a. Unless the position setting lock screws 6a are loosened again and the portable-terminal holder 4a is displaced, even if the portable terminal 10 is temporarily detached from the portable-terminal placing base 3 and placed thereon again, the optical axis 27 of the camera 18 stays substantially aligned with the both centers of the first imaging hole and the second imaging hole 17 without involving any additional positioning.

Alternatively, in the above-described portable-terminal holder 4a, the portable-terminal holding portions 5a may be provided on the rear surface of the portable-terminal placing base 3, and the respective ends of the portable-terminal holding portions 5a may be connected to each other on the front surface of the portable-terminal placing base 3. In this case, the bottom of the portable terminal 10 sits on the connecting unit 8a, and the portable terminal 10 is detachably supported by the connecting unit 8a. The portable-terminal holding portions 5a hold the portable terminal 10 by clamping both the portable terminal 10 and the portable-terminal placing base 3.

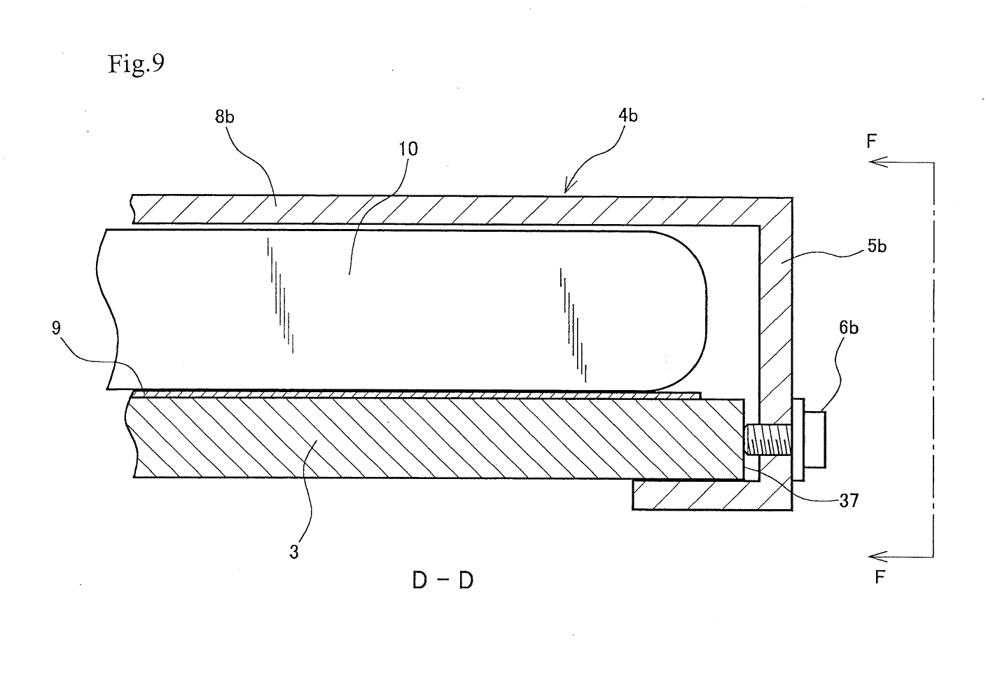

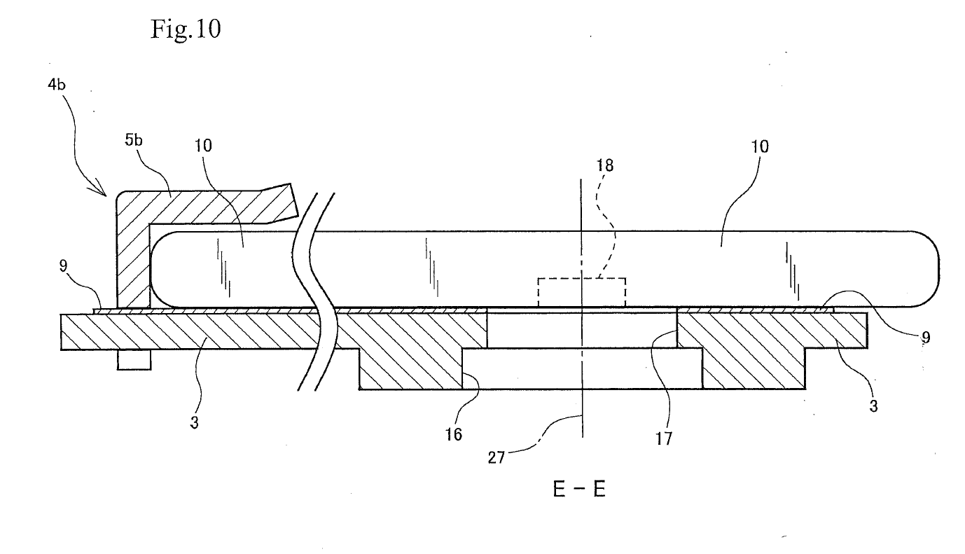

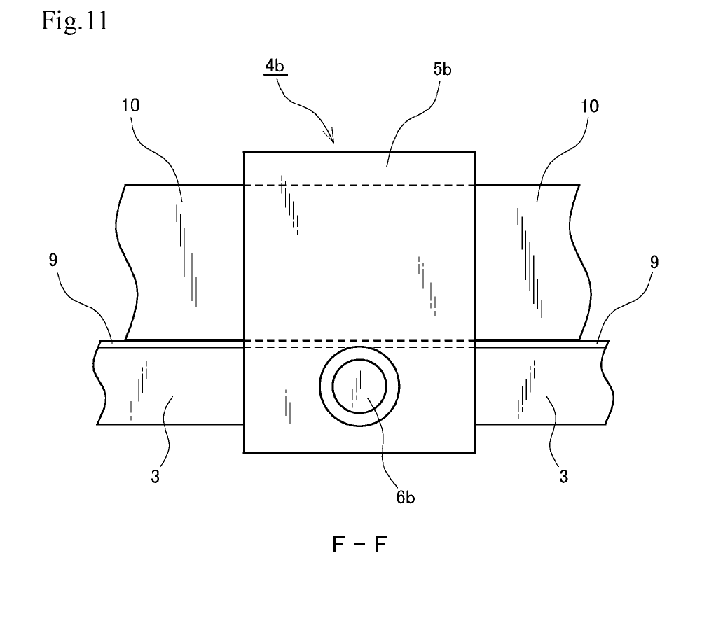

FIG. 9 illustrates a cross section of the portable-terminal holder 4b in the second embodiment, taken along a line D-D in FIG. 5B. FIG. 10 illustrates a cross section thereof, taken along a line E-E in FIG. 5B, and FIG. 11 illustrates a cross section thereof, taken along a line F-F in FIG. 9. The portable-terminal holder 4b in the second embodiment includes: a portable-terminal holding portion 5b shown in FIG. 10 which removably holds the portable terminal 10 at both ends; a storage unit 8b shown in FIG. 9 which accommodates the portable terminal 10; and position setting fixation screws 6b shown in FIG. 11. In the portable-terminal holder 4b, as shown in FIG. 9, the portable-terminal holding portion 5b holds the portable terminal 10 by clamping it together with the portable-terminal placing base 3. More specifically, the portable-terminal holder 4b serves as a stopper which accommodates the portable terminal 10 and clamps it together with the portable-terminal placing base 3, as shown in FIGS. 9 and 10. While the portable terminal 10 is accommodated and positioned in the portable-terminal holder 4b, the position setting fixation screws 6b are tightened to corresponding outer edges 37 of the portable-terminal holding portion 5b and to the portable-terminal holder 4b. As a result, the placement position of the portable terminal 10 is set by the portable-terminal holder 4b. Unless the position setting fixation screws 6b are loosened again and the portable-terminal holder 4b is displaced, when the portable terminal 10 is temporarily removed from the portable-terminal placing base 3 and placed thereon again, the optical axis 27 of the camera 18 stays substantially aligned with the both centers of the first imaging hole and the second imaging hole 17 without involving any additional positioning.

In the portable-terminal holder 4a in the first embodiment shown in FIG. 6, the position setting lock screws 6a are used as a position setting fastener 6, and in the portable-terminal holder 4b in the second embodiment shown in FIG. 9, the position setting fixation screws 6b are used as the position setting fastener 6; however the opposite combination may be possible. In more detail, the position setting fixation screws 6b may be used as the position setting fastener 6 of the portable-terminal holder 4a, and the position setting lock screws 6a may be used as the position setting fastener 6 of the portable-terminal holder 4b. Since each position setting lock screw 6a does not have a screw head and is entirely accommodated in a screw hole, it can have simple dimensions but involves using a tightening jig upon tightening. In contrast, since each positioning fixation screw 6b has a screw head, its dimensions lack simplicity but it can be tightened without using any jig.

### (Indicating Line)

As shown in FIGS. 3 and 4, the portable-terminal placing base 3 is provided with an indicating line 7, which is used to position the portable terminal 10 when the portable terminal 10 is placed. The indicating line 7 includes a short-side indicating segment 7a and a long-side indicating segment 7b. Each of the short-side indicating segment 7a and the long-side indicating segment 7b is printed on the surface of the portable-terminal placing base 3 made of a resin, in the form of a double line. Of the indicating line 7, intersecting segments formed in substantially the center of the first imaging hole 16 in the portable-terminal placing base 3 enables the portable terminal 10 to be positioned easily. In particular, the short-side indicating segment 7a becomes effective in positioning the long side of the portable terminal 10. In these embodiments, the pattern of the indicating line 7 shown in FIGS. 1 and 4, is exemplary and the indicating line 7 may employ any given pattern as long as it is effective in positioning the portable terminal 10.

### (Non-Slip Sheet)

In these embodiments, as shown in FIG. 3, the non-slip sheet 9 having the second imaging hole 17 is deployed between the portable terminal 10 and the portable-terminal placing base 3. As described above, the lens-barrel angle (α) is typically 135°, but if it is approximately 90°, the portable terminal 10 is set in a substantially vertical position. If the lens-barrel angle (α) is approximately 180°, the portable terminal 10 is set in a substantially lateral position. When the lens-barrel angle (α) is approximately 90° and the portable terminal 10 is placed on the portable-terminal placing base 3, it may be unable to be fixed, because it may slip over the portable-terminal placing base 3. In this case, the non-slip sheet 9 which has an adhesive force is deployed between the portable terminal 10 and the portable-terminal placing base 3. The non-slip sheet 9 prevents the portable terminal 10 from being slipped, thereby fixing it. Even when the lens-barrel angle (α) is a typical value, or 135°, the non-slip sheet 9 can also prevent the portable terminal 10 from being moved or angled.

In these embodiments, it is preferable for the non-slip sheet 9 to have transparency that is high enough to identify the indicating segments 7a and 7b provided in the portable-terminal placing base 3. In other words, preferably a transparent or a translucent material is used for the non-slip sheet 9. As a result, even providing the non-slip sheet 9 enables the portable terminal 10 to be positioned in accordance with the indicating segments 7a and 7b. The non-slip sheet 9 may be, for example, a polyurethane elastomer sheet, a polyester elastomer sheet, a polyamide elastomer sheet. There is, however, no limitation on the material of the non-slip sheet 9; it may employ any given material as long as the non-slip sheet 9 enables the portable terminal 10 to be placed on the angled portable-terminal placing base 3 without being slipped and to be easily attached/detached to or from the portable-terminal placing base 3. In these embodiments, as shown in FIG. 4, the non-slip sheet 9 is placed on substantially the overall surface of the portable-terminal placing base 3; however it may be deployed only on part of the surface of the portable-terminal placing bases 3, or it may be dispersed at multiple sites on the surface of the portable-terminal placing base 3.

### (Position Adjusting Manual Stage)

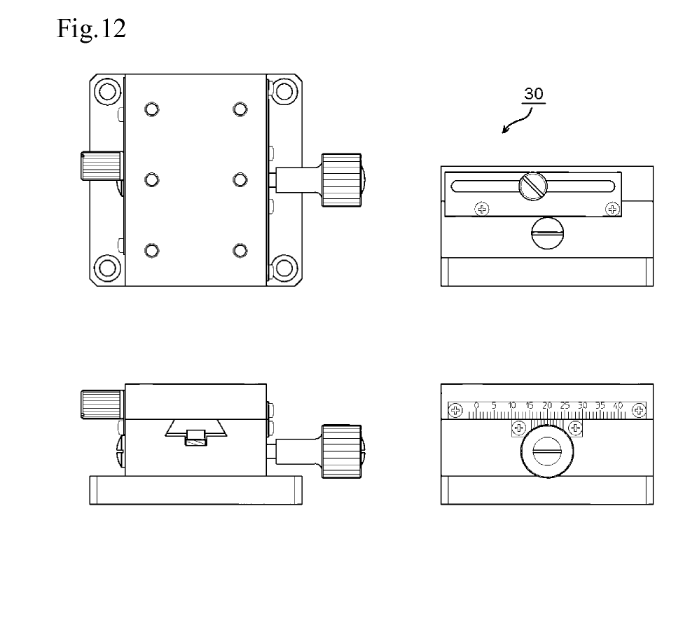

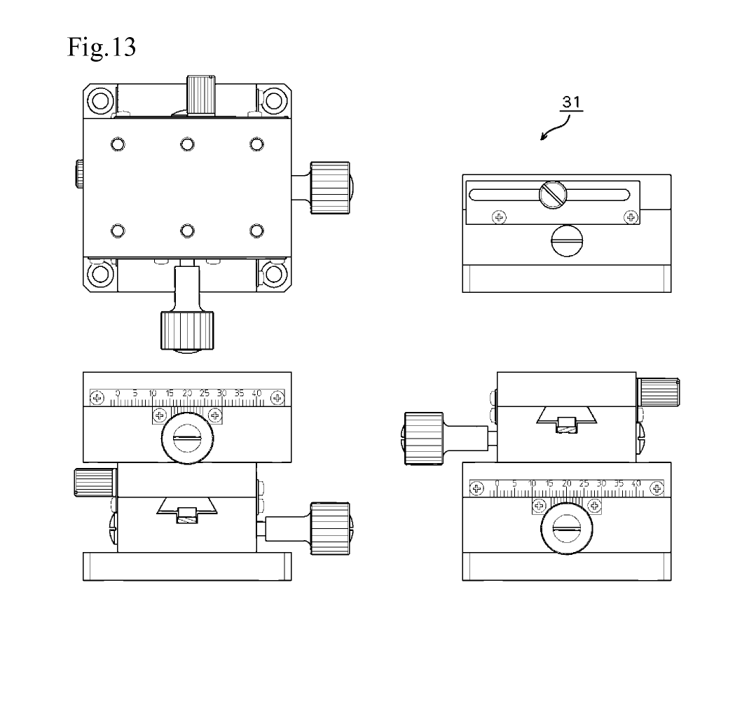

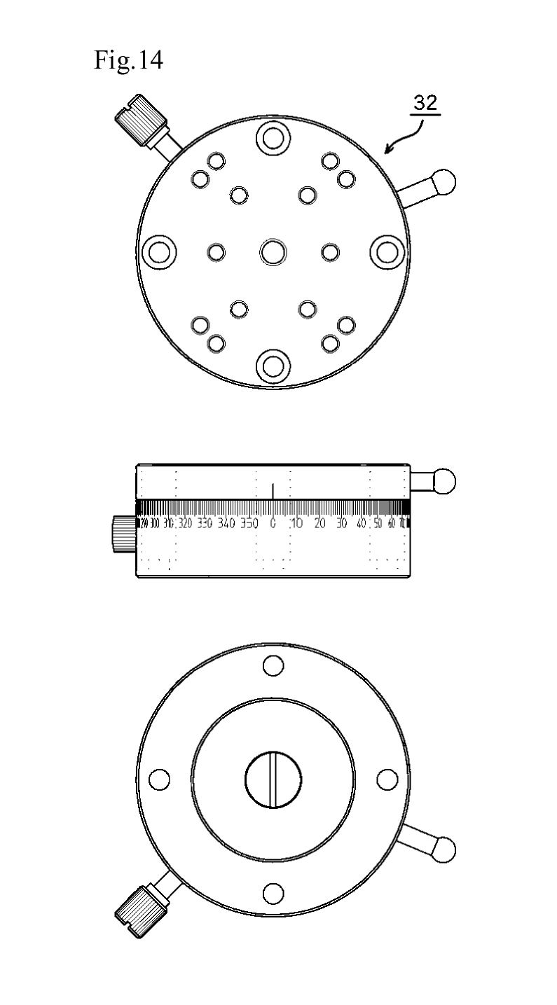

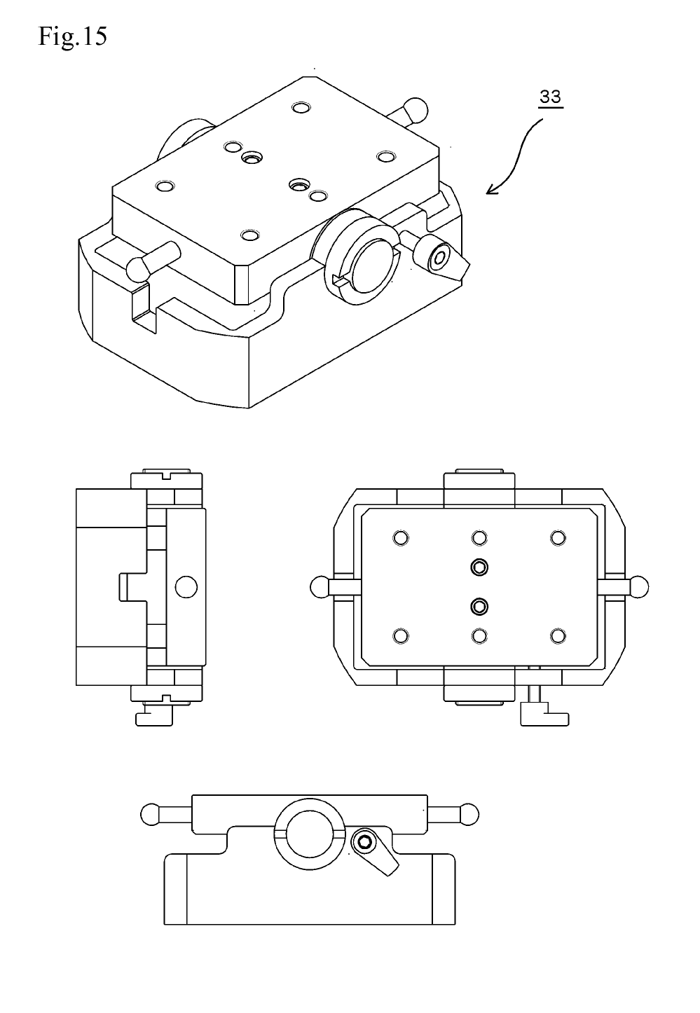

FIGS. 12 to 15 show position adjusting manual stages 30, 31, 32 and 33, respectively, for adjusting the position of the sample 24 to be observed under the microscope which is installed on the stand 23 of the microscope 20. FIG. 12 shows plane and side views of an X-axis stage 30 as an example of a manual stage that slides in one direction. FIG. 13 shows plan and side views of an XY-axis stage 31 as an example of a manual stage that slides in two directions. FIG. 14 shows top, side and bottom views of a rotation stage 32 as an example of a manual stage that slides in a rotational direction. FIG. 15 shows perspective, side and top views of a tilting stage 33 as an example of a manual stage that slides in a tilting direction.

These manual stages 30, 31, 32 and 33 are provided below the sample 24 to be observed under the microscope which is placed on the stand 23 of the microscope 20. With the manual stages 30, 31, 32 and 33, the back-and-forth, right-and-left and rotational positions of the sample 24 can be adjusted in such a way that the sample 24 is substantially aligned with the optical axis of the portable terminal 10. As a result, the position of an image observed under the microscope 20 can be adjusted in such a way that the image is aligned with the optical axis 27 of the camera 18 in the portable terminal 10.

For the manual stages 30, 31, 32 and 33, a single stage is selected alone or multiple stages are selected in combination from among the X-axis stage 30 that slides in one direction, the XY-axis stage 31 that slides in two intersecting directions, the rotation stage 32 that slides in a rotational direction, and the tilting stage 33 whose stage is angled. The selected stage or stages are installed in an exchangeable manner. Examples of the combination of the stages include manual stages 30 and 33 that are a combination of X-axis stage 30 and tilting stage 33, manual stages 31 and 32 that are a combination of the XY-axis stage 31 and rotation stage 32, and the like. Two or more of the manual stages 30, 31, 32 and 33 may be selected in combination in accordance with the type of the sample 24 to be observed under the microscope 20 or an observation purpose, and they may be installed below the sample 24. With the combination of the manual stages, the position of the image to be observed under the microscope 20 can be adjusted in a short-side direction, a long-side direction, a rotational direction, a tilting direction, or a combination thereof. As a result, the image is aligned with the camera 18 of the portable terminal 10.

### (Microscopic Imaging Method Using Portable Terminal Adaptor)

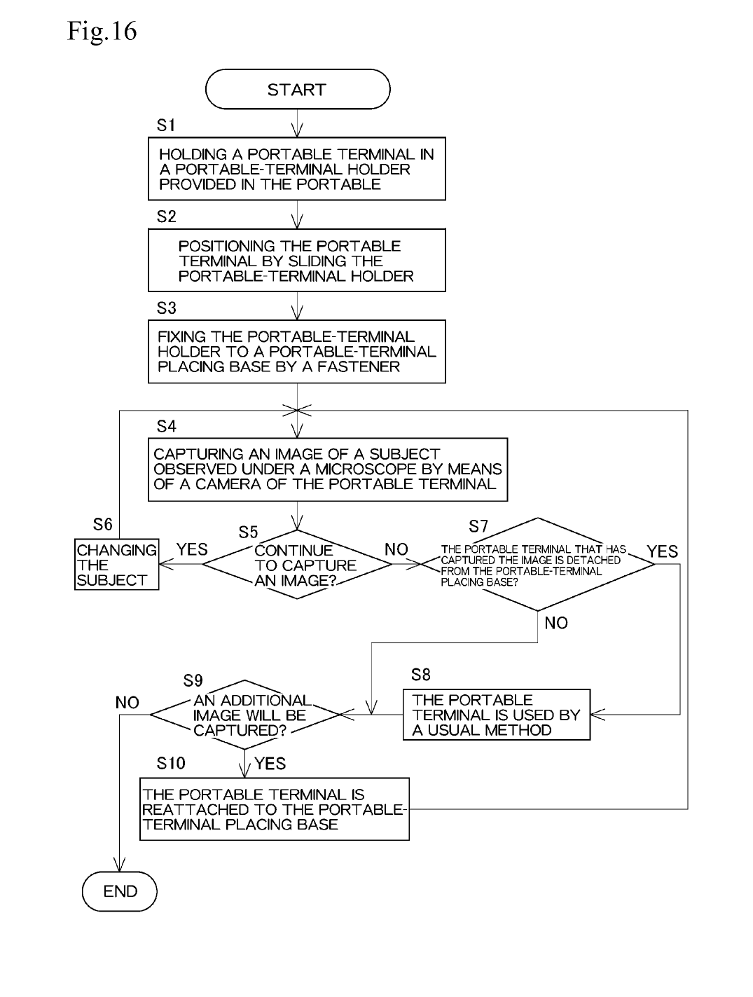

FIG. 16 is a flowchart of a microscopic imaging method using the portable terminal adaptor 1 according to an embodiment. Steps are denoted by reference characters S1 to S10. Herein, two methods will be described as examples of the microscopic imaging method using the portable terminal adaptor 1, by which the camera 18 of the portable terminal 10 captures an image observed under the microscope. The first method includes a step at which the attached position of the portable terminal 10 is initially set and used. The second method includes a step at which the portable terminal 10 is used under the condition that its attached position has been already initially set.

First of all, the first method will be described. The portable terminal 10 is held on the portable-terminal holder 4 provided in the portable terminal adaptor 1 (S1). Then, the portable-terminal holder 4 is slid, so that the portable terminal 10 is positioned (S2). In this case, the portable terminal 10 may be positioned with the help of the indicating line 7. If the non-slip sheet 9 is used, the positioned portable terminal 10 can be reliably fixed by means of the adhesive force of the non-slip sheet 9. Then, the portable-terminal holder 4 is fixed to the portable-terminal placing base 3 by the fastener 6 (S3). The camera 18 of the portable terminal 10 captures an image of a subject observed under the microscope 20 (S4). The above-described microscopic imaging method using the portable terminal adaptor 1 corresponds to an initial setting process for the microscopic imaging method using a predetermined portable terminal 10. Thus, when the portable terminal 10 is used for the first time, it is necessary to set the position of the portable terminal 10 relative to the portable-terminal placing base 3, in such a way that the optical axis 27 of the camera 18 is substantially aligned with the optical axis 26 of the lens-barrel 21.

Next, the second method will be described. In the case where the portable terminal 10 that has been initially set is temporarily detached from the portable-terminal placing base 3, then is reattached thereto, and is used, no additional initial setting is required. This is because the portable-terminal holder 4 has already been positioned and fixed during the initial setting. The processing is branched depending on whether or not the portable terminal 10 that has been initially set will further capture an image (S5). If an image is further captured (YES), the subject is changed (S6), and the processing returns to Step (S4) at which the camera 18 of the portable terminal 10 captures an image of the subject observed under the microscope 20. Even if an image is captured by another theme without changing the subject, the processing may also return to Step (S4). Otherwise, if any image is no longer captured (NO), the processing is branched depending on whether or not the portable terminal 10 that has captured the image is detached from the portable-terminal placing base 3 (S7). If the portable terminal 10 is not detached (NO), the processing is branched depending on whether or not an additional image will be captured (S9). An exemplary case is that the image data is processed using an application function of the portable terminal 10 while the portable terminal 10 stays placed on the portable-terminal placing base 3. If the portable terminal 10 is detached, the portable terminal 10 is used by a usual method (S8). In this case, for example, a user has the portable terminal 10 in the hand, and uses it to call someone or transmit or receive E-mails, or the image data is processed by the application function of the portable terminal 10. Examples of this data process include processes through which: a length or angle is measured using an application of a smart phone or the like; an image is colored; and an image is transmitted to a remote site by a communication function of a smart phone or the like. In the case where the primary function of the portable terminal 10 is used or image data is processed, the portable terminal 10 that has captured an image may either be detached from the portable-terminal placing base 3 or stay attached thereto.

Then, it is determined whether or not an additional image will be captured by the portable terminal 10 that has captured the image (S9). If any image will be no longer captured (NO), the microscopic imaging method using the portable terminal adaptor is terminated. Otherwise, if an additional image will be captured, the portable terminal 10 is reattached to the portable-terminal placing base 3 (S10). Then, the processing returns to Step (S4) at which the camera 18 of the portable terminal 10 captures an image of a subject observed under the microscope 20. When the second method is performed, no additional initial setting is required, because the portable-terminal holder 4 is fixed to the portable-terminal placing base 3 by the fastener 6 at Step 4. Thus, even when the same portable terminal 10 is used multiple times, as long as it is initially set once, an image observed under the microscope 20 can be captured without any additional setting, that is, through a simple operation. However, if a different portable terminal 10 is used, it is necessary to perform the initial setting by the first method.

The above-described microscopic imaging method using the portable terminal adaptor 1 includes the step at which the portable terminal 10 is positioned relative to the portable-terminal placing base 3, on the basis of the indicating segments 7a and 7b provided in the portable-terminal placing base 3. With the help of the indicating segments 7a and 7b provided in the portable-terminal placing base 3, the portable terminal 10 can be positioned easily, and the above microscopic imaging method enables the portable terminal adaptor 1 to conform to specifications of portable terminals 10 which differ for each model.

Furthermore, the above-described microscopic imaging method using the portable terminal adaptor 1 includes the step at which the non-slip sheet 9 is deployed between the portable terminal 10 and the portable-terminal placing base 3. Because of this step, even when the portable terminal 10 is placed on the angled portable-terminal placing base 3, it can be fixed to the portable-terminal placing base 3 by means of the adhesive force of the non-slip sheet 9, without being slipped, moved or angled.

### REFERENCE NUMERALS

1 Portable terminal adaptor for microscope
2 Lens-barrel attachment
Portable-terminal placing base
4, 4a, 4b Portable-terminal holder
5, 5a, 5b Portable-terminal holding portion
6 Position setting fastener
6a Position setting lock screws
6b Position setting fixation screws
7 Indicating line
7a Short-side indicating segment
7b Long-side indicating segment
8 Main body
8a Connecting unit
8b Storage unit
9 Non-slip sheet
10 Portable terminal
11 Base fixation screws
12, 12a, 12b Base fixation screw holes
13 Attachment fixation screws
14 Flat part
15 Cylinder part
16 First imaging hole
17 Second imaging hole
18 Camera
19 Eyepiece cap screw
20 Microscope
21 Lens-barrel
22 Stand
23 Base for stand
24 Sample
25 Optical axis of microscope (Optical axis of object lens)
26 Optical axis of lens-barrel (Optical axis of eyepiece)
27 Optical axis of portable terminal
28 Object lens
29 Eyepiece
30 X-axis stage
31 XY-axis stage
32 Rotation stage
33 Tilting stage
34 Fixation screw handle
35 Fine adjustment sliding handle
36 Slit
37 Outer edge
α Lens-barrel angle

1. A portable terminal adaptor for a microscope, the portable terminal adaptor being provided in a microscope to capture an image observed under the microscope by means of a camera of a portable terminal, the portable terminal adaptor comprising:
a lens-barrel attachment fixed to a lens-barrel of the microscope;
a portable-terminal placing base having a first imaging hole through which the image observed under the microscope passes, the portable terminal being placed on the portable-terminal placing base; and
a portable-terminal holder holding the portable terminal placed on the portable-terminal placing base.

2. The portable terminal adaptor for a microscope according to claim 1, wherein
the portable-terminal holder comprises a portable-terminal support unit detachably supporting a bottom of the portable terminal, and a position setting lock screw, and
a placement position of the portable terminal that has been supported and positioned by the portable-terminal holder is set in the portable-terminal holder by tightening the position setting lock screw to a side of the portable-terminal holder.

3. The portable terminal adaptor for a microscope according to claim 1, wherein
the portable-terminal holder comprises a portable-terminal storage unit removably accommodating the portable terminal, and a position setting fixation screw, and
a placement position of the portable terminal that has been accommodated and positioned in the portable-terminal holder is set in the portable-terminal holder by tightening the position setting fixation screw to a side of the portable-terminal holder.

4. The portable terminal adaptor for a microscope according to one of claims 1 to 3, wherein
the portable-terminal placing base is provided with an indicating line that is used as a reference mark when the portable terminal is positioned, and the indicating line at least indicates a substantially central position of the first imaging hole provided in the portable-terminal placing base.

5. The portable terminal adaptor for a microscope according to claim 4, further comprising a non-slip sheet deployed between the portable terminal and the portable-terminal placing base, the non-slip sheet having a second imaging hole and having transparency that is high enough to identify the indicating line provided in the portable-terminal placing base.

6. The portable terminal adaptor for a microscope according to claim 1, wherein
the lens-barrel attachment is composed of a flat part and a cylinder part,
the cylinder part is provided with a U-shaped slit in its axial direction, and
the cylinder part is attached to the lens-barrel by putting an eyepiece cap screw provided in the lens-barrel into the U-shaped slit.

7. The portable terminal adaptor for a microscope according to claim 1, further comprising a manual stage provided in the microscope for adjusting back-and-forth and right-and-left positions of a sample so as to be substantially aligned with an optical axis of the portable terminal.

8. The portable terminal adaptor for a microscope according to claim 7, wherein
the manual stage is composed of a stage selected alone or a plurality of stages selected in combination from among an X-axis stage that slides in one direction, an XY-axis stage that slides in two intersecting directions, a rotation stage that slides in a rotational direction, and a tilting stage whose stage slides in a tilting direction, and
the manual stage is installed in an exchangeable manner and the adjustment of the positions is performed.

9. A microscopic imaging method using a portable terminal adaptor, the portable terminal adaptor allowing a camera of a portable terminal to capture an image observed under a microscope, the microscopic imaging method comprising the steps of:
holding the portable terminal in a portable-terminal holder provided in the portable terminal adaptor;
positioning the portable terminal by sliding the portable-terminal holder;
fixing the portable-terminal holder to the portable-terminal placing base by a fastener; and
capturing an image of a subject observed under the microscope with the camera of the portable terminal.

10. The microscopic imaging method using a portable terminal adaptor for a microscope according to claim 9, further comprising the steps of:
detaching the portable terminal that has captured the image, from the portable-terminal holder;
reattaching the portable terminal to the portable-terminal holder fixed to the portable-terminal placing base; and
capturing an image of a subject observed under the microscope with the camera of the portable terminal.

11. The microscopic imaging method using a portable terminal adaptor for a microscope according to claim 9 or 10, further comprising the step of positioning the portable terminal relative to the portable-terminal placing base, on the basis of an indicating line provided in the portable-terminal placing base.

12. The microscopic imaging method using a portable terminal adaptor for a microscope according to claim 9, further comprising the step of deploying a non-slip sheet between the portable terminal and the portable-terminal placing base.
